(19) United States
(12) Patent Application Publication
(10) Pub. No.: US 2011/0235677 A1
(43) Pub. Date: Sep. 29, 2011

(54) DIGITAL THERMOMETER STRUCTURE

(75) Inventor: Chao-Man TSENG, Taipei (TW)

(73) Assignee: K-Jump Health Co., Ltd.

(21) Appl. No.: 12/729,361

(22) Filed: Mar. 23, 2010

(51) Int. Cl. G01K 7/00

(52) U.S. Cl. 374/170; 374/E07.001

(57) ABSTRACT

A digital thermometer includes a sensing case, a display case, and an electronic control unit. The sensing case includes a sensing rod at its front end and a core portion at its rear end where a window is formed on the core portion. The display case is movably sheathed onto the core portion, and a display cover is installed onto the display case at a position corresponding to the window. The electronic control unit includes a control circuit board and a display screen electrically coupled to the control circuit board. The control circuit board is installed at a backside of the core portion, and the display screen is installed corresponding to the window. With the sensing case and the display case, the case structure of the electronic clinical thermometer can be simplified to reduce costs and improve the easiness to be waterproof.

### FIELD OF THE INVENTION

The present invention generally relates to electronic measuring devices, in particular to a digital thermometer for measuring body temperatures.

### BACKGROUND OF THE INVENTION

As electronic technologies advance, various different electronic products including electronic medical devices are developed rapidly. In the past, mercury thermometer is generally used as a clinical instrument for measuring body temperature. Since the mercury thermometer is usually made of a glass tube, and mercury may leak or flow out easily when the glass tube is impacted by an external force, therefore, digital thermometer gradually replaces the conventional mercury thermometer to avoid accidents.

Generally, present existing digital thermometers include a main body with a sensor installed at an end of the thermometer, a PCB holder equipped with an electronic control unit, and a distal cover coupled to the top of the main body. After the distal cover is removed, the electronic control unit installed in the PCB holder can be taken out, so that a battery can be installed, removed or changed. However, such structural design leads to a higher cost because it requires three sets of molds—the main body and PCB holder and the distal cover. Furthermore, it is unfavorable to be waterproof because such structural design has many joints that come from the connection between components.

In view of the foregoing shortcomings of the conventional digital thermometer, the inventor of the present invention, based on years of experience in the related industry to conduct extensive researches and experiments, finally designed and developed a feasible digital thermometer structure to overcome the shortcomings of the prior art.

### SUMMARY OF THE INVENTION

Therefore, the objective of the present invention is to provide an improved digital thermometer structure comprising two cases only. In this way, the invention has three major advantages. First, manufacturing cost can be reduced because the device simply requires two sets of molds. Second, labor cost can be reduced because the assembling process is easier. Third, it is easier to meet the waterproof requirement because the overall structure of the digital thermometer has only one joint.

To achieve the foregoing objective, the present invention discloses an improved digital thermometer structure comprises a sensing case, a display case, and an electronic control unit. The front end of the sensing case constitutes a sensing rod, and a rear end of the sensing case is coupled to a core portion. The core portion includes a window formed thereon. The display case is movably sheathed onto the core portion, and the display case includes a display cover installed at a position corresponding to the window. The electronic control unit includes a control circuit board and a display screen electrically coupled to the control circuit board, and the control circuit board is installed at a backside of the core portion, and the display screen is installed at a position corresponding to the window.

### BRIEF DESCRIPTION OF THE DRAWINGS

FIG. 1 is an exploded view of a first preferred embodiment of the present invention;

FIG. 2 is a perspective view of a first preferred embodiment of the present invention;

FIG. 3 is a cross-sectional view of a first preferred embodiment of the present invention;

FIG. 4 is an exploded view of a second preferred embodiment of the present invention;

FIG. 5 is a perspective view of a second preferred embodiment of the present invention; and

FIG. 6 is a cross-sectional view of a second preferred embodiment of the present invention.

### DESCRIPTION OF THE PREFERRED EMBODIMENTS

The technical characteristics and contents of the present invention will become apparent with the following detailed description accompanied with related drawings. The drawings are provided for the purpose of illustrating the present invention only, but not intended for limiting the scope of the invention.

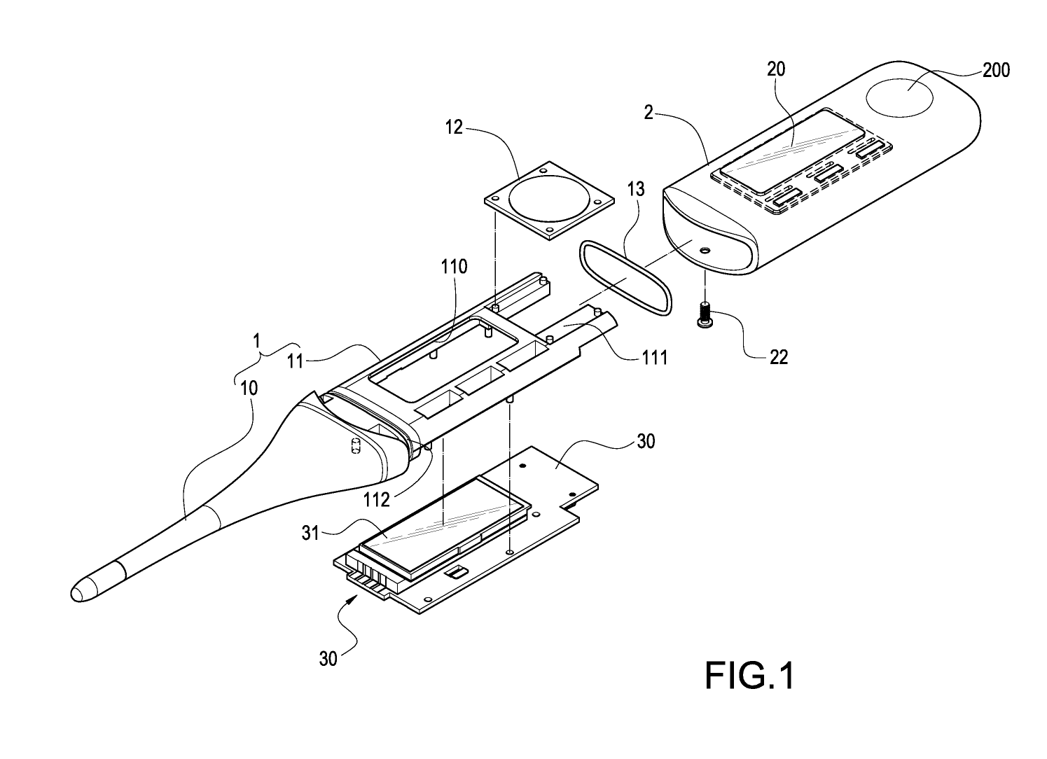

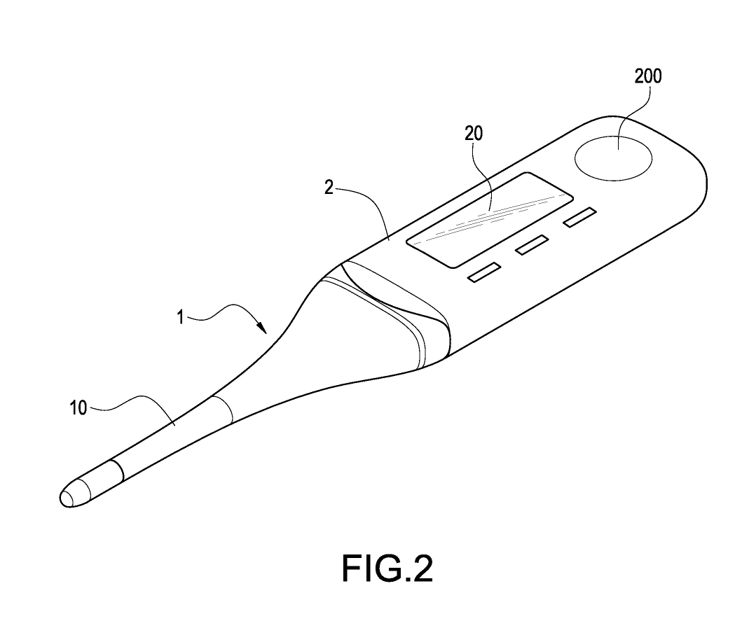

With reference to FIGS. 1 and 2 for an exploded view and a perspective view of an electronic clinical thermometer structure in accordance with a first preferred embodiment of the present invention respectively, the electronic clinical thermometer structure comprises a sensing case 1, a display case 2, and an electronic control unit 3.

A front end of the sensing case 1 constitutes a sensing rod 10, and a rear end of the sensing case 1 is coupled to a core portion 11, wherein the sensing rod 10 can be made of a hard material or a soft material, and the sensing rod 10 of this preferred embodiment is made of a hard material and integrally formed with the core portion 11, and the core portion 11 includes a window 110 formed thereon, and a press button base 111 disposed on a lateral side of the window 110 for installing a press switch 12, and the press switch 12 can be a touch control switch.

The display case 2 is movably sheathed and covered onto the core portion 11 of the sensing case 1, and coupled with the sensing rod 10 to constitute the external appearance of the digital thermometer. The display case 2 includes a display cover 20 installed at a position corresponding to the window 110 of the core portion 11 and a O-ring 13 installed between the display case 2 and the core portion 11, and the core portion 11 includes a circular groove 112 formed at a position proximate to a lateral side of the sensing rod 10 and provided for sheathing and fixing the O-ring 13. In addition, the display case 2 and the core portion 11 can be installed and secured with each other by a screw element 22, wherein the screw element 22 can be a screw. The display case 2 further includes a pressing portion 200 with a waterproof effect formed at a position corresponding to the press switch 12 of the sensing case 1.

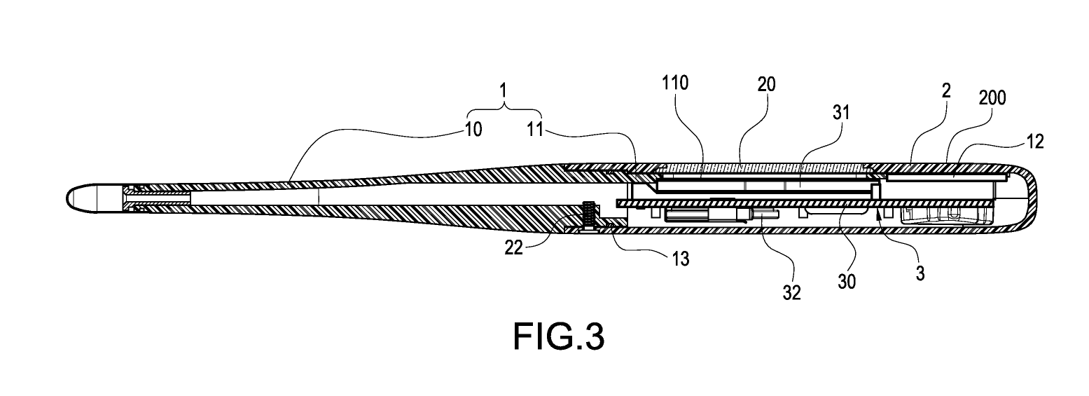

The electronic control unit 3 is fixed and stacked onto the backside of the core portion 11 of the sensing case 1, and the electronic control unit 3 is comprised of a control circuit board 30 and a display screen 31 electrically coupled to the control circuit board 30, and the control circuit board 30 is installed at a backside of the core portion 11, and the display screen 31 is installed at a position corresponding to the window 110 of the core portion 11 to facilitate the display case 2 to be sheathed onto the core portion 11 and allow users to view a display status or related data through the display screen 31 from the display cover 20 of the display case 2. In FIG. 3, a battery 32 of the electronic control unit 3 is installed under the control circuit board 30.

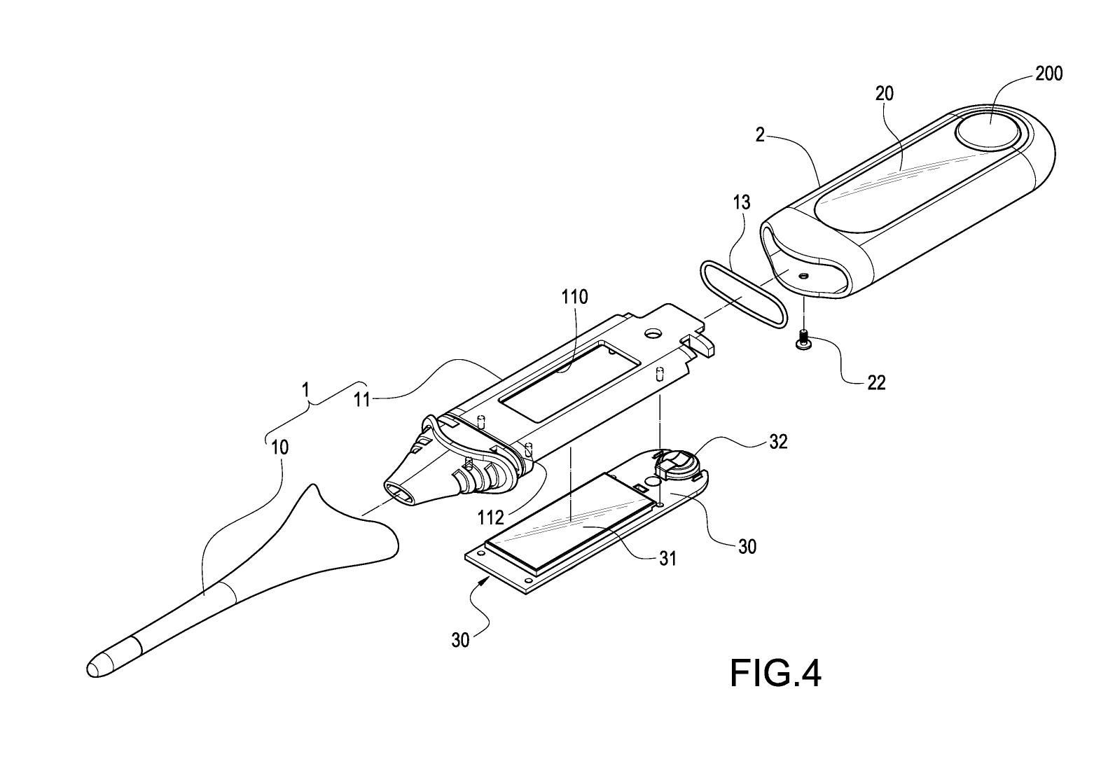

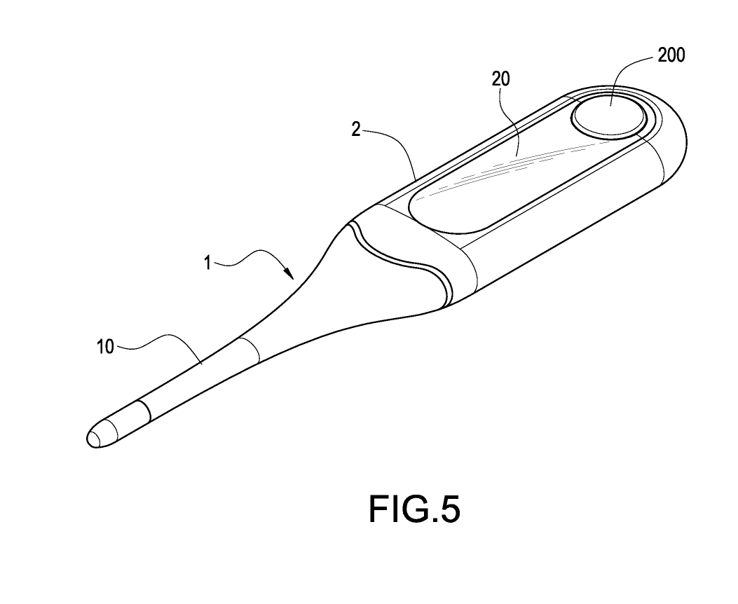

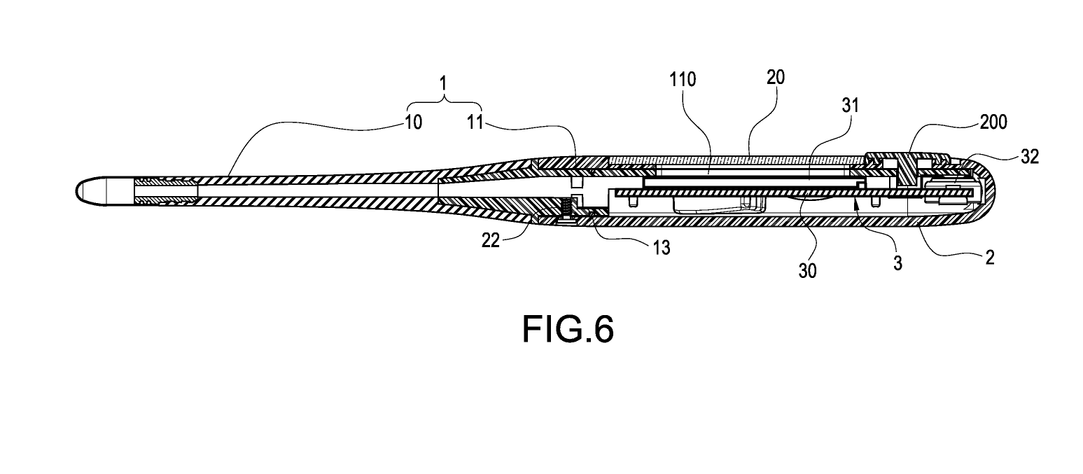

With reference to FIGS. 4 and 5 for an exploded view and a perspective view of a second preferred embodiment of the present invention respectively, the sensing rod 10 is made of a soft material and formed by a double injection molding process and coupled with the core portion 11, and the pressing portion 200 is exposed from the display case 2. In the second preferred embodiment as shown in FIG. 6, the battery 32 of the electronic control unit 3 is installed on the control circuit board 30 and at a position corresponding to the pressing portion 200, such that the pressing portion 200 can be pressed directly to trigger or operate the electronic control unit 3. In addition, the pressing portion 200 is also made of a soft material and coupled to the display case 2 by a double injection molding process.

With the aforementioned structure, the improved digital thermometer structure of the present invention can be achieved.

In the improved digital thermometer structure of the present invention, the sensing case 1 and the display case 2 constitute a casing structure of the digital thermometer, so that the number of the molds and the molding cost can be reduced. Since the manufacturing process involves a simple connection of the sensing case 1 with the display case 2, the production and manufacturing processes can be simplified. Furthermore, the structural design has one joint only, so the waterproof requirement can be met easily. If a user wants to change a battery 32, the user simply needs to remove the display case 2 from the core portion 11 of the sensing case 1 to replace the battery 32 easily.

In summation of the description above, the present invention improves over the prior art and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A digital thermometer structure, comprising:
a sensing case having a sensing rod at its front end and a core portion coupled to its rear end, the core portion having a window formed thereon;
a display case movably sheathed onto the core portion, the display case having a display cover installed thereon at a position corresponding to the window; and
an electronic control unit comprising a control circuit board and a display screen electrically coupled to the control circuit board, the control circuit board being installed at a backside of the core portion, and the display screen being installed corresponding to the window.

2. The digital thermometer structure of claim 1, wherein the sensing rod is made of a hard material and integrally formed with the core portion.

3. The digital thermometer structure of claim 1, wherein the sensing rod is made of a soft material and covered and formed onto the core portion.

4. The digital thermometer structure of claim 1, wherein the core portion includes a press button base disposed on a side of the window, the press button base includes a press switch, and the display case includes a pressing portion formed at a position corresponding to the press switch of the sensing case.

5. The digital thermometer structure of claim 4, wherein the pressing portion is exposed from the display case.

6. The digital thermometer structure of claim 4, wherein the pressing portion is made of a soft material and formed on the display case by a double injection molding.

7. The digital thermometer structure of claim 1, further comprising an O-ring installed between the display case and the core portion.

8. The digital thermometer structure of claim 7, wherein the core portion includes a circular groove formed at a position proximate to a lateral side of the sensing rod, and the O-ring is sheathed and fixed onto the groove.

9. The digital thermometer structure of claim 1, wherein the display case and the core portion are installed and secured with each other through a screw element.

10. The digital thermometer structure of claim 9, wherein the screw element is a screw.
